(19) United States
(12) Patent Application Publication
(10) Pub. No.: US 2025/0242310 A1
(43) Pub. Date: Jul. 31, 2025

(54) FLUORINE-CONTAINING WASTEWATER TREATMENT SYSTEM

(71) Applicant: Samsung Electronics Co., Ltd., Suwon-si (KR)

(72) Inventors: Daeseon Park, Suwon-si (KR); DongYeun Koh, Daejeon (KR); David Kim, Suwon-si (KR); Jimin Park, Daejeon (KR); Daeok Kim, Suwon-si (KR)

(73) Assignee: SAMSUNG ELECTRONICS CO., LTD., Suwon-si (KR)

(21) Appl. No.: 18/830,208

(22) Filed: Sep. 10, 2024

(30) Foreign Application Priority Data
Jan. 26, 2024 (KR) 10-2024-0011968

(51) Int. Cl. B01D 61/28; B01D 61/24; B01D 63/02; B01D 67/00; B01D 69/02; B01D 69/08; C02F 1/26; C02F 1/44; C02F 1/66; C02F 101/14

(52) U.S. Cl. CPC B01D 61/28; B01D 61/246; B01D 63/02; B01D 69/02; B01D 69/08; C02F 1/26; C02F 1/44; C02F 1/66; B01D 67/0088; B01D 67/0093; B01D 2325/38; C02F 2101/14; C02F 2301/046

(57) ABSTRACT

A fluorine-containing wastewater treatment system includes a separation membrane contactor including a hydrophobic separation membrane having a plurality of pores, the separation membrane contactor performing a separation process by the hydrophobic separation membrane, a first supply assembly configured to supply treatment target water containing fluorine to the separation membrane contactor, a second supply assembly configured to supply an absorbent to the separation membrane contactor. The absorbent is physically separated from the treatment target water by the hydrophobic separation membrane, and the fluorine of the treatment target water is absorbed by the absorbent through the plurality of pores of the hydrophobic separation membrane, using the separation process.

### CROSS-REFERENCE TO RELATED APPLICATION(S)

This application claims benefit of priority to Korean Patent Application No. 10-2024-0011968 filed on Jan. 26, 2024 in the Korean Intellectual Property Office, the disclosure of which is incorporated herein by reference in its entirety.

### BACKGROUND

The present disclosure relates to a fluorine-containing wastewater treatment system.

In a fluorine-containing wastewater treatment system, when a coagulation and settlement process is performed to separate fluorine from fluorine-containing wastewater, a large amount of inorganic sludge may be generated. Accordingly, with respect to the fluorine-containing wastewater treatment system, continuous research into a method for reducing the generation of inorganic sludge has been conducted.

### SUMMARY

An aspect of the present disclosure provides a fluorine-containing wastewater treatment system for recovering wastewater by highly concentrating fluorine in order to minimize the generation of a large amount of inorganic sludge and to recycle the wastewater.

According to an aspect of the present disclosure, there is provided a fluorine-containing wastewater treatment system including: a separation membrane contactor including a hydrophobic separation membrane having a plurality of pores, the separation membrane contactor performing a separation process by the hydrophobic separation membrane; a first supply assembly configured to supply treatment target water containing fluorine to the separation membrane contactor; a second supply assembly configured to supply an absorbent to the separation membrane contactor, the absorbent being physically separated from the treatment target water by the hydrophobic separation membrane, and the fluorine of the treatment target water being absorbed by the absorbent through the plurality of pores of the hydrophobic separation membrane using the separation process; a first treated water recovery assembly configured to selectively recover first treated water having a first fluorine concentration from the separation membrane contactor, the first treated water being treated water obtained by treating the treatment target water using the separation process; and a second treated water recovery assembly configured to selectively recover second treated water having a second fluorine concentration from the separation membrane contactor, the second treated water being solution containing the absorbent including the fluorine from the treatment target water using the separation process. The first fluorine concentration may be within a first weight management range of the separation process. The second fluorine concentration may be higher than a second weight management range of the separation process, and the second weight management range may be greater than the first weight management range.

According to another aspect of the present disclosure, there is provided a fluorine-containing wastewater treatment system including: a separation membrane contactor including a hydrophobic hollow fiber membrane having a plurality of pores, the separation membrane contactor performing a separation process with the hydrophobic hollow fiber membrane; a first supply assembly configured to supply treatment target water containing fluorine such that the treatment target water is in contact with an external surface of the hydrophobic hollow fiber membrane of the separation membrane contactor; a second supply assembly configured to supply an absorbent such that the absorbent is in contact with an internal surface of the hydrophobic hollow fiber membrane of the separation membrane contactor; and a first treated water recovery assembly configured to selectively recover first treated water containing a first fluorine concentration from the separation membrane contactor using the separation process. The fluorine of the treatment target water may be converted into gas-phase fluorine in a portion adjacent to the plurality of pores using the separation process, and the gas-phase fluorine may diffuse toward the absorbent through the plurality of pores, and may be absorbed by the absorbent. The first fluorine concentration may be within a first weight management range of the separation process.

According to another aspect of the present disclosure, there is provided a fluorine-containing wastewater treatment system including: a separation membrane contactor including a hydrophobic separation membrane having a plurality of pores, the separation membrane contactor performing a separation process by the hydrophobic separation membrane; a first supply assembly configured to supply treatment target water containing fluorine to the separation membrane contactor; a second supply assembly configured to supply an absorbent to the separation membrane contactor, wherein the absorbent is physically separated from the treatment target water by the hydrophobic separation membrane, and the fluorine of the treatment target water is absorbed by the absorbent through the plurality of pores of the hydrophobic separation membrane using the separation process; a treatment target water pretreatment assembly disposed between the first supply assembly and the separation membrane contactor, the treatment target water pretreatment assembly configured to inject acid to maintain a pH of the treatment target water at less than an acid ionization constant (pKa) of the fluorine; a first treated water recovery assembly configured to selectively recover first treated water containing a first fluorine concentration from the separation membrane contactor, wherein the first treated water is treated water obtained by treating the treatment target water using the separation process, and a second treated water recovery assembly configured to selectively recover second treated water containing a second fluorine concentration from the separation membrane contactor, wherein the second treated water is a solution containing the absorbent including the fluorine from the treatment target water using the separation process. The first fluorine concentration may be within a first weight management range of the separation process. The second fluorine concentration may be higher than a second weight management range of the separation process. The first weight management range may be a range in which the first fluorine concentration is 0.1 wt % or less relative to a weight of the first treated water. The second weight management range may be a range in which the second fluorine concentration is at least twice a concentration of the fluorine of the treatment target water.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a block diagram of an example of a fluorine-containing wastewater treatment system according to an example embodiment of the present disclosure;

FIG. 2 is a detailed diagram of an example of a fluorine-containing wastewater treatment system according to an example embodiment;

FIG. 3 is a block diagram of a fluorine-containing wastewater treatment system according to an example embodiment;

FIG. 4 is a schematic partially enlarged view of a fluorine-containing wastewater treatment system according to an example embodiment;

FIG. 5A is a schematic plan view of a fluorine-containing wastewater treatment system according to an example embodiment;

FIG. 5B is a schematic partially enlarged view of a fluorine-containing wastewater treatment system according to an example embodiment;

FIG. 5C is a schematic partially enlarged view of a fluorine-containing wastewater treatment system according to an example embodiment;

FIG. 6 is a schematic partially enlarged view of a fluorine-containing wastewater treatment system according to an example embodiment;

FIGS. 7A and 7B are schematic partially enlarged views of a fluorine-containing wastewater treatment system according to an example embodiment; and

FIG. 8 is a detailed diagram of an example of a fluorine-containing wastewater treatment system according to an example embodiment.

### DETAILED DESCRIPTION

Hereinafter, preferred example embodiments of the present disclosure will be described with reference to the attached drawings.

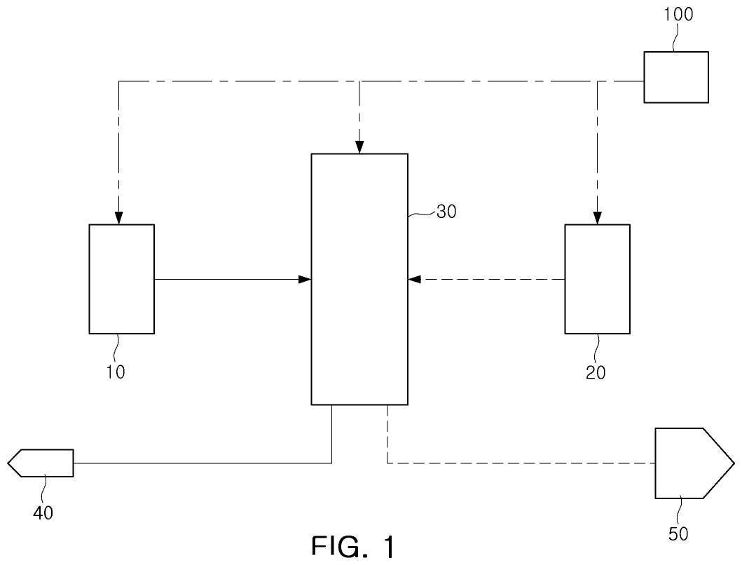

FIG. 1 is a block diagram of an example of a fluorine-containing wastewater treatment system 1 according to an example embodiment of the present disclosure.

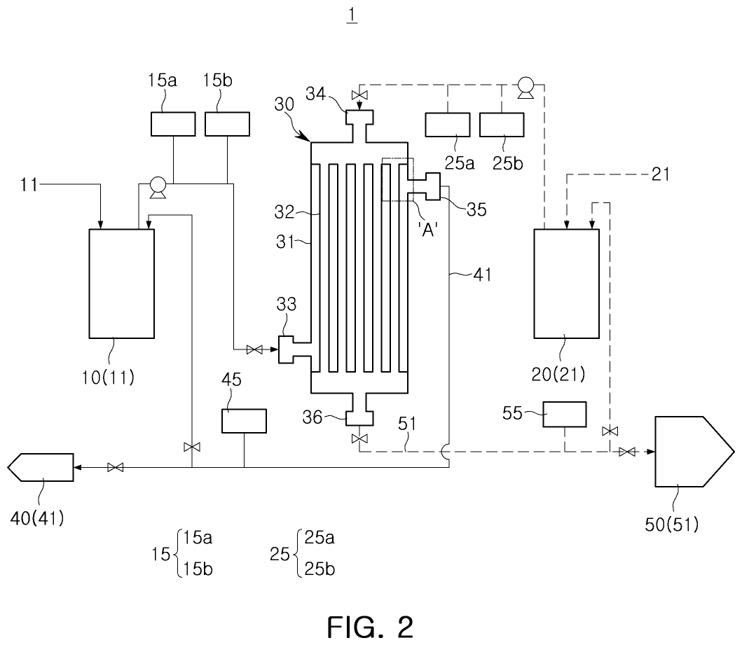

FIG. 2 is a detailed diagram of an example of the fluorine-containing wastewater treatment system 1 according to an example embodiment.

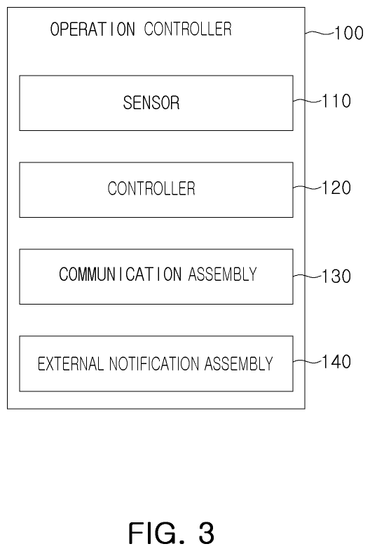

FIG. 3 is a block diagram of the fluorine-containing wastewater treatment system 1 according to an example embodiment.

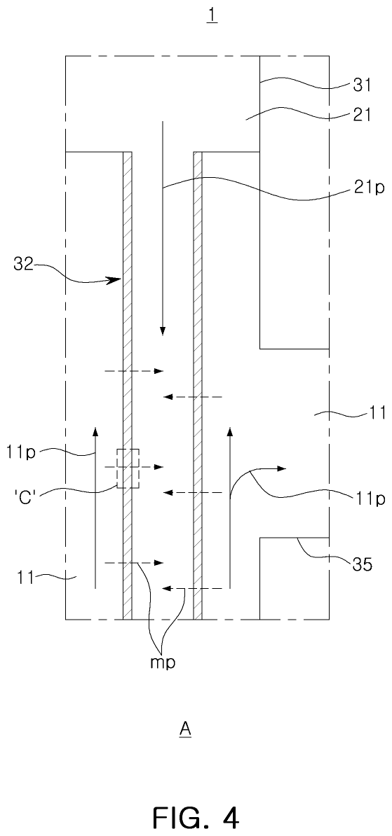

FIG. 4 is a schematic partially enlarged view of the fluorine-containing wastewater treatment system 1 according to an example embodiment, and is an enlarged view of region “A” of FIG. 2.

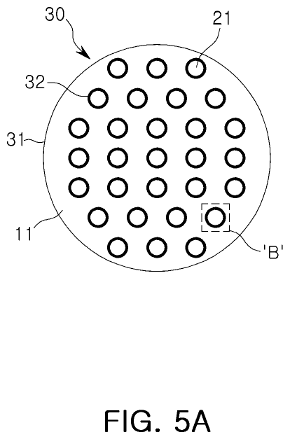

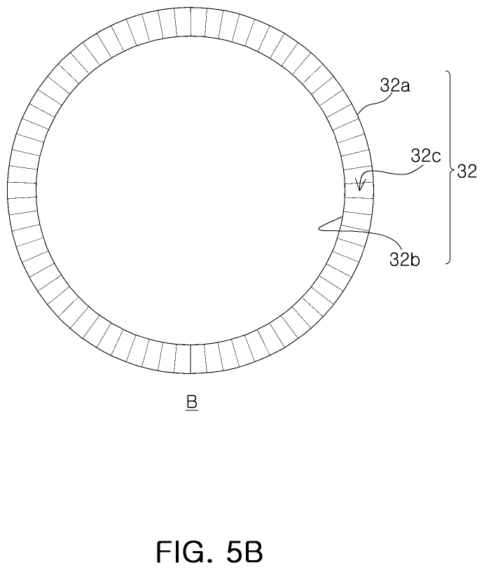

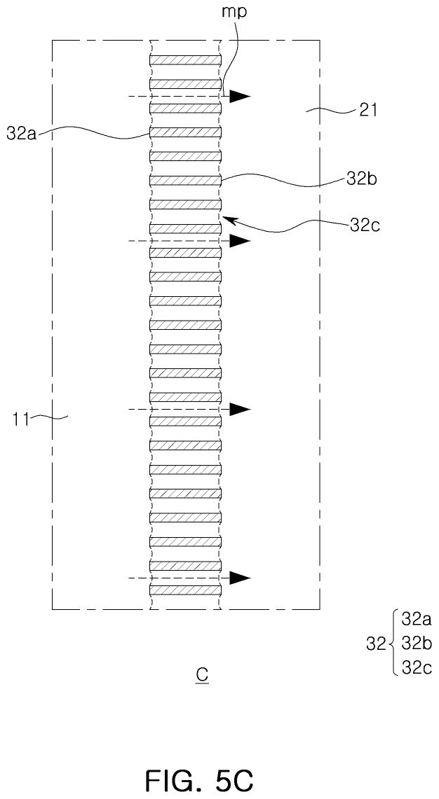

FIG. 5A is a schematic plan view of the fluorine-containing wastewater treatment system 1 according to an example embodiment, for example, a plan view of a separation membrane contactor. FIG. 5B is a schematic partially enlarged view of the fluorine-containing wastewater treatment system 1 according to an example embodiment, and is an enlarged view of region “B” of FIG. 5A. FIG. 5C is a schematic partially enlarged view of the fluorine-containing wastewater treatment system 1 according to an example embodiment, and is an enlarged view of region “C” of FIG. 4.

Referring to FIGS. 1 to 5C, the fluorine-containing wastewater treatment system 1 according to an example embodiment of the present disclosure may include a separation membrane contactor 30 including a separation membrane 32, a first supply assembly 10 storing treatment target water 11 and supplying the treatment target water 11 to the separation membrane contactor 30, a second supply assembly 20 storing an absorbent 21 and supplying the absorbent 21 to the separation membrane contactor 30, a first treated water recovery assembly 40 recovering first treated water 41 from which the fluorine has been removed by the separation membrane contactor 30, and a second treated water recovery assembly 50 recovering second treated water 51 in which the fluorine is concentrated by the separation membrane contactor 30. According to an example embodiment, the fluorine-containing wastewater treatment system 1 may further include an operation controller 100 measuring states of the first and second supply assemblies 10 and 20 and the separation membrane contactor 30, and controlling operations of the first and second supply assemblies 10 and 20 and the separation membrane contactor 30.

The first supply assembly 10 may be an assembly storing wastewater 11 containing a predetermined contaminant, and supplying the wastewater 11 to the separation membrane contactor 30 to recover the contaminant from the wastewater 11 and to concentrate the contaminant. Here, the wastewater 11 may be referred to as treatment target water treated by the separation membrane contactor 30 to treat the contaminant, and the contaminant may be referred to as a treatment target substance.

The wastewater 11 according to the present disclosure may be contaminated water discharged during a semiconductor process including a printing process, an etching process, and a cleaning process of a semiconductor wafer. The wastewater 11 may include, for example, inorganic wastewater including acid/alkaline wastewater, copper-containing wastewater, and fluorine-containing wastewater, and organic wastewater including high-concentration organic matter-containing wastewater and solvent wastewater.

The wastewater 11 according to the present disclosure may be wastewater containing fluorine discharged during the semiconductor process. Accordingly, the fluorine-containing wastewater treatment system 1 according to the present disclosure may be a system 1 for treating fluorine-containing wastewater discharged during the semiconductor process. The fluorine-containing wastewater 11 according to the present disclosure may be hydrofluoric acid in which hydrogen fluoride is dissolved in water.

The wastewater 11 according to the present disclosure may be treatment target wastewater containing a low concentration of fluorine. The concentration of the fluorine may be 10 wt % or less, for example, more than 0 wt % and 10 wt % and less, 1 wt % or more and 10 wt % and less, or 1 wt % or more and 5 wt % or less, relative to a weight of the wastewater 11.

The fluorine-containing wastewater treatment system 1 may further include a wastewater pretreatment assembly 15 (or “treatment target water pretreatment assembly”) provided between the first supply assembly 10 and the separation membrane contactor 30.

The wastewater pretreatment assembly 15 may include a first pretreatment assembly 15a adjusting a pH of the wastewater 11, and a second pretreatment assembly 15b removing particulate matter from the wastewater 11.

The first pretreatment assembly 15a may be an assembly configured to inject acid into the first supply assembly 10 to maintain the pH of the wastewater 11 at less than an acid ionization constant (pKa) of fluorine. For example, the first pretreatment assembly 15a may be configured to inject hydrochloric acid such that the pH of the wastewater 11 is 2.0 or less. Maintaining the pH of the wastewater 11 at less than the acid ionization constant (pKa) of fluorine may prevent fluorine (for example, “hydrogen fluoride”) from being present as a fluorine ion in the wastewater 11, and thus fluorine may be effectively separated by the separation membrane contactor 30.

The second pretreatment assembly 15b may be an assembly configured to filter particulate matter present in the wastewater 11. The particulate matter may be defined as suspended matter of a liquid or solid substance such as an aerosol or the like. In other words, the second pretreatment assembly 15b may be an assembly for removing filterable substances other than the treatment target substance (for example, fluorine) according to the present disclosure.

The first pretreatment assembly 15a and the second pretreatment assembly 15b may be provided in a different order, as necessary. For example, the second pretreatment assembly 15b may be provided first, followed by the first pretreatment assembly 15a.

The second supply assembly 20 may be an assembly storing the absorbent 21 and supplying the absorbent 21 to the separation membrane contactor 30.

The absorbent 21 may be a substance for treating the contaminant from the wastewater 11 supplied from the first supply assembly 10 to the separation membrane contactor 30. The absorbent 21 may be, for example, a basic solution for treating fluorine contained in the wastewater 11. The absorbent 21 may be, for example, a basic solution selected from the group consisting of NaOH, KOH, and NH₄OH. Accordingly, fluorine contained in the wastewater 11 may be absorbed by the absorbent 21 and fixed as a fluorine salt such as NaF, KF, and NH₄F. According to an example embodiment of the present disclosure, a process of fixing fluorine contained in the wastewater 11 as the fluorine salt may be referred to as a separation process or a treatment process. For efficiency of the separation process or the treatment process, it may be preferable that the fluorine salt is precipitated during the separation process. Accordingly, the absorbent 21 may not contain Ca(OH)₂.

The fluorine-containing wastewater treatment system 1 may further include an absorbent pretreatment assembly 25 provided between the second supply assembly 20 and the separation membrane contactor 30.

The absorbent pretreatment assembly 25 may include a first pretreatment assembly 25a adjusting a concentration of the absorbent 21, and a second pretreatment assembly 25b removing particulate matter in the absorbent 21.

The first pretreatment assembly 25a may prevent the fluorine salt from being excessively generated and precipitated by adjusting the concentration of the absorbent 21. The concentration of the absorbent 21 may be adjusted in various manners depending on a concentration of fluorine contained in the wastewater 11, a type of the absorbent 21, the solubility of the fluorine salt, process temperature, and process time. For example, when the solubility of the fluorine salt is considered, a concentration of the absorbent 21 containing KOH or NH₄OH may be higher than a concentration of the absorbent 21 containing NaOH.

More specifically, when the concentration of fluorine contained in the wastewater 11 is 1 wt % or more and 5 wt % or less, the concentration of the absorbent 21 containing KOH or NH₄OH may be 10 wt % or less, for example, 3 wt % to 10 wt %, 3 wt % to 7 wt %, or 4 wt % to 6 wt %, relative to a weight of the absorbent 21. With respect to the above-described concentration range of fluorine having the same range, the concentration of the absorbent 21 containing NaOH may be 5 wt % or less, for example, 1 wt % to 5 wt %, 1 wt % to 3 wt %, or 1 wt % to 2 wt %.

The second pretreatment assembly 25b may be an assembly configured to filter particulate matter present in the absorbent 21. The particulate matter may be defined as suspended matter of a liquid or solid substance such as aerosol or the like. For example, the particulate matter may be a fluorine salt unnecessarily precipitated during the separation process and reintroduced into the second supply assembly 25 by an absorbent circulation assembly 55. In other words, the second pretreatment assembly 25b may be an assembly for removing filterable substances other than the absorbent 21 according to the present disclosure.

Similarly, the first pretreatment assembly 25a and the second pretreatment assembly 25b may be provided in a different order, as necessary. For example, the second pretreatment assembly 25b may be provided first, followed by the first pretreatment assembly 25a.

Operations of the treatment target water pretreatment assembly 15 and the absorbent pretreatment assembly 25 may be controlled by the operation controller 100.

Referring to FIG. 3, the operation controller 100 may include a sensor 110 (or “monitoring assembly”) checking a condition or state of each assembly, a controller 120 controlling an operation of each assembly, a communication assembly 130 performing external communication, and an external notification assembly 140 externally notifying an operation result.

For example, the sensor 110 may be connected to the first supply assembly 10 to measure a concentration of fluorine of the wastewater 11 in the first supply assembly 10, a pH of the wastewater 11 in the first supply assembly 10, and a concentration of suspended matter of the wastewater 11 in the first supply assembly 10. Similarly, the sensor 110 may be connected to the second supply assembly 20 to measure a concentration of the absorbent 21 in the second supply assembly 20, a pH of the absorbent 21 in the second supply assembly 20, and a concentration of suspended matter of the absorbent 21 in the second supply assembly 20.

The sensor 110 may also be connected to the separation membrane contactor 30 to measure a concentration and a pH of water treated by the separation membrane contactor 30, which will be described below.

The controller 120 may control an operation of each assembly based on a result of sensing performed by the sensor 110. For example, an operation of the first pretreatment assembly 15a may be controlled by the controller 120 depending on results of measuring a concentration of fluorine of the wastewater 11 and a pH of the wastewater 11, and an operation of the second pretreatment assembly 15b may be controlled depending on a result of measuring a concentration of suspended matter of the wastewater 11. Similarly, an operation of the first pretreatment assembly 25a may be controlled by the controller 120 depending on results of measuring a concentration and a pH of the absorbent 21, and an operation of the second pretreatment assembly 25b may be controlled by the controller 120 depending on a result of measuring a concentration of suspended matter of the absorbent 21.

Operations results of the sensor 110 and the controller 120 may be provided to an external server or manager through a communication assembly 130, and the external server or manager may verify, based on result information displayed through an external notification assembly 140, whether the fluorine-containing wastewater treatment system 1 is smoothly operated.

The separation membrane contactor 30 may include a body 31, and a separation membrane 32 embedded in the body 31 to perform the separation process.

The body 31 may include a plurality of inlets for supplying the wastewater 11 and the absorbent 21 to the separation membrane 32, and a plurality of outlets for discharging the first treated water 41 and the second treated water 51 from the separation membrane contactor 30.

The plurality of inlets may include, for example, a first inlet channel 33 (or “first shell side inlet”) disposed on a lower side portion of the body 31, the first inlet channel 33 for receiving the wastewater 11 from the first supply assembly 10, and a first inlet 34 (or “first tube side inlet”) disposed on an upper portion of the body 31, the first inlet 34 for receiving the absorbent 21 from the second supply assembly 20. The plurality of outlets may include, for example, a first outlet channel 35 (or “first shell side outlet”) disposed on an upper side portion of the body 31, the first outlet channel 35 for discharging the first treated water 41, and a first outlet 36 (or “first tube side outlet”) disposed on a lower portion of the body 31, the first outlet 36 for discharging the second treated water 51.

In the separation membrane contactor 30, a wastewater flow direction 11p and an absorbent flow direction 21p may be different directions. For example, the wastewater flow direction 11p may be defined as a bulk flow of the wastewater 11. In this case, the wastewater flow direction 11p may be a first direction, for example, a vertical upward direction. That is, the wastewater 11 may flow to be injected into the first inlet channel 33 on the lower side portion and discharged through the first outlet channel 35 on the upper side portion. The absorbent flow direction 21p of may be a second direction, opposite to the first direction, for example, a vertical downward direction. That is, the absorbent 21 may be injected into the first inlet 34 on the upper portion and discharged through the first outlet 36 on the lower portion.

The separation membrane 32 may be configured to physically separate the wastewater 11 injected into the first inlet channel 33 and the absorbent 21 injected into the first inlet 34. For example, an upper portion of the separation membrane 32 may be connected to the first inlet 34 in a sealed state, and a lower portion of the separation membrane 32 may be connected to the first outlet 36 in a sealed state.

Referring to FIGS. 5A and 5B, the separation membrane 32 may be a membrane that is in the form of a hollow fiber having a circular internal surface 32b and an external surface 32a surrounding the internal surface. In this case, the wastewater 11, injected into the first inlet channel 33, may flow in the first direction (for example, a vertical upward direction) along the external surface 32a of the separation membrane 32, and the absorbent 21, injected into the first inlet 34, may flow in the second direction (for example, a vertically downward direction) along the internal surface 32b of the separation membrane 32. The form of the separation membrane 32 is not limited to the hollow fiber. For example, the separation membrane 32 may have a flat sheet membrane.

The separation membrane 32 may include a hydrophobic separation membrane. Accordingly, a “membrane wetting phenomenon,” in which pores of a separation membrane are wetted by the wastewater 11 or the absorbent 21 to reduce substance transfer efficiency, may be minimized. In particular, a treatment target substance according to the present disclosure may have increased substance transfer efficiency.

The separation membrane 32 may be, for example, a hydrophobic separation membrane including a hydrophobic polymer selected from the group consisting of polytetrafluoroethylene (PTFE), polypropylene (PP), polyvinylidene fluoride (PVDF), and polydimethylsiloxane (PDMS), but the present disclosure is not limited thereto.

The separation membrane 32 may be, for example, a separation membrane having a hydrophobic membrane by subjecting a membrane surface of the hydrophilic polymer to hydrophobic surface treatment. The hydrophobic surface treatment may include plasma polymerization and silane coating. The plasma polymerization may form a branched polymer on the membrane surface by activating a fluorine-containing monomer, thereby changing the properties of the membrane surface. Here, the hydrophilic polymer may be selected from the group consisting of polyethersulfone (PES) and cellulose nitrate (CN), and the membrane surface of the hydrophilic polymer may be hydrophobized by a fluorine compound (for example, tetrafluoromethane or octafluorocyclobutane) or silicone polymer (for example, silicone rubber). The silane coating may react an organosilane having reactive silanol species with a hydroxy group of the membrane surface, such as a hydrophilic polymer or ceramic membrane (for example, zirconia and alumina), to form a separation membrane having a hydrophobic membrane having low surface energy.

The separation membrane 32 may have a plurality of pores 32c formed along the internal surface 32b to the external surface 32a, or along the external surface 32a to the internal surface 32b. Here, a substance transfer path mp may be formed through the plurality of pores 32c in a direction from the external surface 32a to the internal surface 32b. The substance transfer path mp may be a path through which fluorine, contained in the wastewater 11 in contact with the external surface 32a, diffuses in a direction toward the absorbent 21 in contact with the internal surface 32b. According to the present disclosure, the fluorine may be converted into gas-phase fluorine in the vicinity of the pores 32c positioned in the external surface 32a according to Henry's law, and may move along the substance transfer path mp, and may be fixed to the absorbent 21.

Referring to FIG. 5C, the plurality of pores 32c may have a symmetrical structure in a membrane thickness direction of the separation membrane 32. For example, the plurality of pores 32c may have a slit pore-type structure. As a result, a “membrane fouling phenomenon,” in which pores of a separation membrane are blocked by substances other than a treatment target substance to reduce the separation efficiency of the treatment target substance, may be reduced. That is, as the plurality of pores 32c have a slit pore structure, the treatment target substance (for example, fluorine) may have increased separation efficiency.

At least a portion of fluorine may be removed from the wastewater 11 using the separation process, and accordingly the first treated water 41 having a first fluorine concentration may be generated. In other words, the first treated water 41 may be the treatment target water 11 treated using the separation process. That is, the first treated water 41 may be the treatment target water 11 from which at least a portion of a contaminant (for example, fluorine) has been removed using the separation process.

The first treated water 41 may be discharged through the first outlet channel 35 of the separation membrane contactor 30. The first treated water 41 may be recovered by the first treated water recovery assembly 40 when the first fluorine concentration is within a first weight management range of the separation process, and may be reintroduced into the first supply assembly 10 by a treated water circulation assembly 45 when the first fluorine concentration is outside the first weight management range. Whether the first fluorine concentration is within the first weight management range may be sensed by the sensor 110, provided in the first outlet channel 35 of the separation membrane contactor 30. A recovery or reintroduction operation of the first treated water recovery assembly 40 may be operated by the controller 120.

The first weight management range, for example, the first fluorine concentration, may be 0.5 wt % or less, for example, 0 wt % or more and 0.5 wt % or less, 0 wt % or more and 0.3 wt % or less, or 0 wt % or more and 0.1 wt % or less, relative to a weight of the first treated water. As an example, the first fluorine concentration can be about 0.1 wt % or less relative to a weight of the first treated water (in the context of this specification, the term “about” means+5%).

According to the separation process, the absorbent 21 may absorb fluorine from the wastewater 11, and thus the second treated water 51 having a second fluorine concentration may be generated. In other words, the second treated water 51 may be the absorbent 21 performing the separation process. That is, the second treated water 51 may be the absorbent 21 absorbing a contaminant (for example, fluorine) from the treatment target water 11, using the separation process.

The second treated water 51 may be discharged through the first outlet 36 of the separation membrane contactor 30. The second treated water 51 may be recovered by the second treated water recovery assembly 50 when the second fluorine concentration of the second treated water 51 is within a second weight management range of the separation process, and may be reintroduced into the second supply assembly 20 by the absorbent circulation assembly 55 when the second fluorine concentration is outside the second weight management range. Whether the second fluorine concentration is within the second weight management range may be sensed by the sensor 110, provided in the first outlet 36 of the separation membrane contactor 30. A recovery or reintroduction operation of the second treated water recovery assembly 50 may be operated by the controller 120.

The second weight management range may be a range in which the second fluorine concentration is greater than a fluorine concentration of the treatment target water 11 introduced and/or reintroduced into the first supply assembly 10. For example, the second weight management range may be a range in which the second fluorine concentration is at least twice greater than the fluorine concentration of the treatment target water 11 introduced and/or reintroduced into the first supply assembly 10. The second weight management range, for example, the second fluorine concentration, may be 10 wt % or more, for example, 10 wt % or more and 50 wt % or less, 20 wt % or more and 40 wt % or less, or 30 wt % or more and 40 wt % or less, relative to a weight of the second treated water.

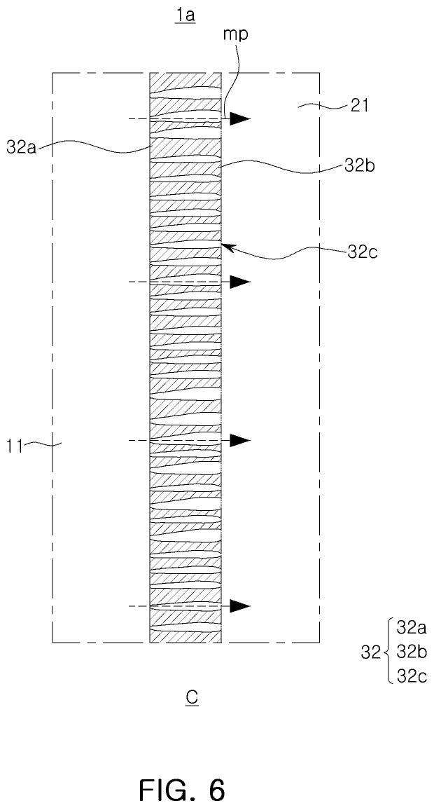

FIG. 6 is a schematic partially enlarged view of a fluorine-containing wastewater treatment system 1a according to an example embodiment.

Referring to FIG. 6, the fluorine-containing wastewater treatment system 1a according to the present disclosure may be the same as or similar to that described with reference to FIGS. 1 to 5C, except that a plurality of pores 32c may have an asymmetrical structure in a membrane thickness direction of a separation membrane 32.

Referring to FIG. 6, the plurality of pores 32c may have, for example, a finger-like structure. The finger-like structure may be a structure in which an average pore size (for example, a diameter or cross-sectional area) of the pores 32c increases from an external surface 32a to an internal surface 32b. Accordingly, an average pore size of the pores 32c, positioned in the external surface 32a, may be smaller than an average pore size of the pores 32c, positioned in the internal surface 32b. As the pores 32c have a finger-like structure, a membrane fouling phenomenon may be minimized, and at the same time a separation membrane may have increased mechanical strength.

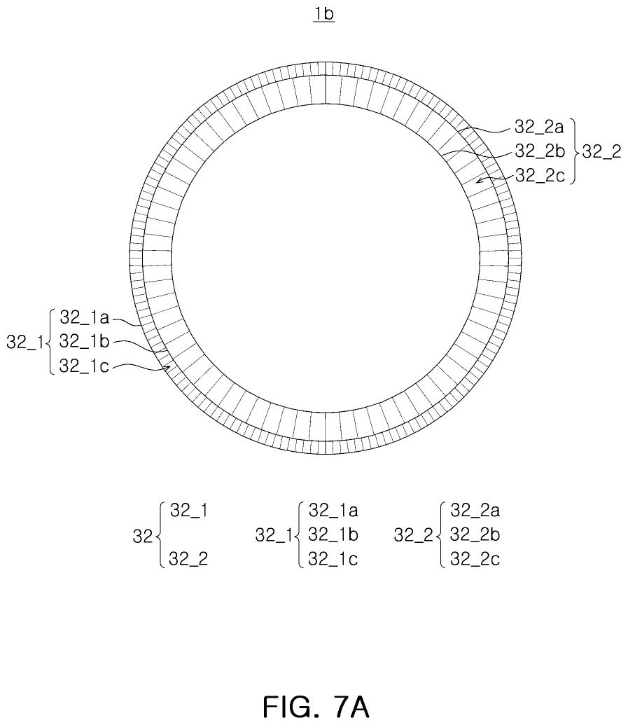

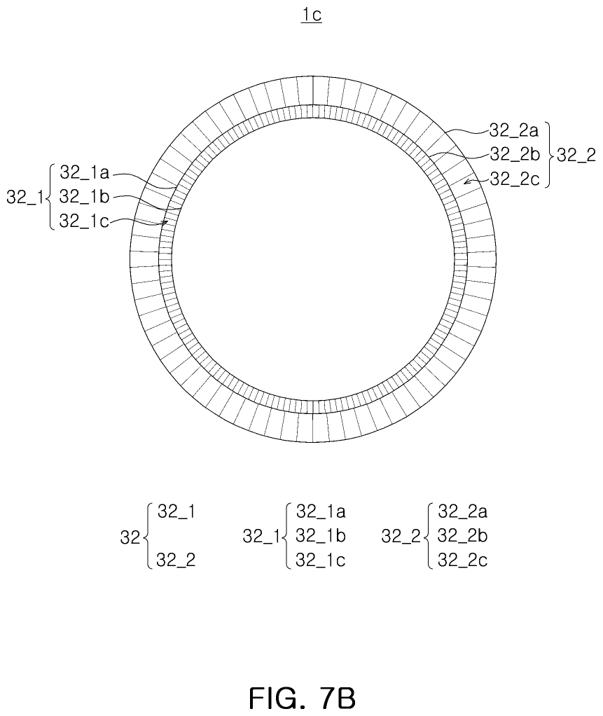

FIG. 7A is a schematic partially enlarged view of a fluorine-containing wastewater treatment system 1b according to an example embodiment. FIG. 7B is a schematic partially enlarged view of a fluorine-containing wastewater treatment system 1c according to an example embodiment.

Referring to FIGS. 7A and 7B, the fluorine-containing wastewater treatment systems 1b and 1c according to the present disclosure may be the same as or similar to those described with reference to FIGS. 1 to 6, except that a separation membrane 32 may include a composite membrane including a plurality of membranes.

Referring to FIG. 7A, the separation membrane 32 may include a second separation membrane 32_2, and a first separation membrane 32_1 disposed on the outside of the second separation membrane 32_2. The second separation membrane 32_2 may have features the same as or similar to those of the separation membrane 32 described with reference to FIGS. 1 to 6, and thus a detailed description will be omitted.

An internal surface 32_1b of the first separation membrane 32_1 may be disposed on an external surface 32_2a of the second separation membrane 32_2 to increase the mechanical strength of the separation membrane 32. The first separation membrane 32_1 may include a membrane denser than the second separation membrane 32_2. For example, the first separation membrane 32_1 may have pores 32_1c having an average pore size smaller than an average pore size of pores 32_2c of the second separation membrane 32_2. Accordingly, a membrane fouling phenomenon may be reduced. In addition, a membrane wetting phenomenon, in which pores of a separation membrane are wetted by wastewater or an absorbent to reduce substance transfer efficiency, may also be minimized.

Referring to FIG. 7B, the fluorine-containing wastewater treatment system 1c according to the present disclosure may be the same as or similar to those described with reference to FIGS. 1 to 7A, except that the first separation membrane 32_1 described with reference to FIG. 7A is disposed on the inside of the second separation membrane 32_2.

Specifically, an external surface 32_1a of the first separation membrane 32_1 may be disposed on an internal surface 32_2b of the second separation membrane 32_2 to increase the mechanical strength of the separation membrane 32, and the first separation membrane 32_1 may include a membrane denser than the second separation membrane 32_2. Accordingly, the membrane fouling phenomenon and membrane wetting phenomenon described with reference to FIG. 7A may be minimized.

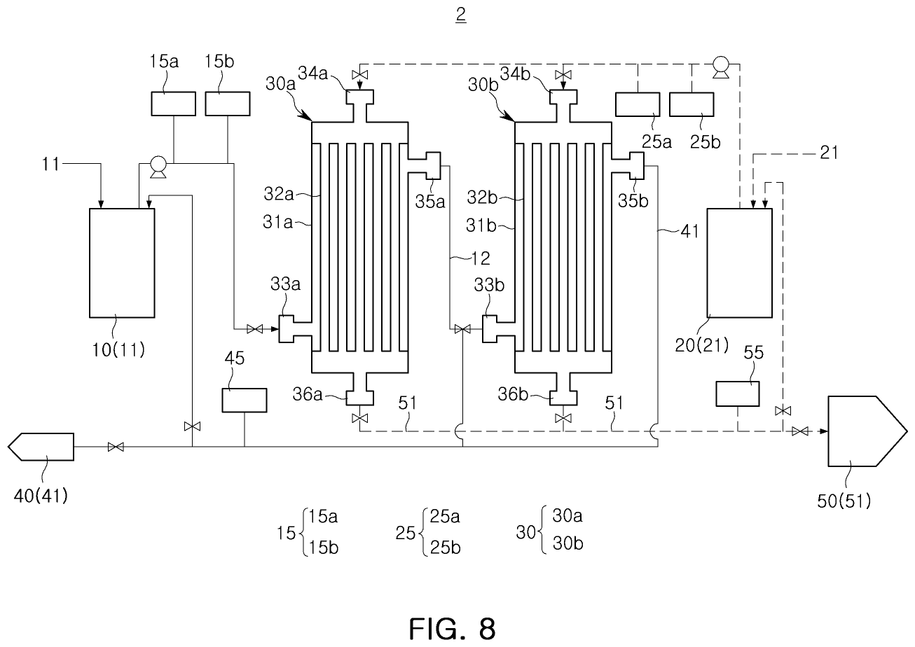

FIG. 8 is a detailed diagram of an example of a fluorine-containing wastewater treatment system 2 according to an example embodiment.

Referring to FIG. 8, the fluorine-containing wastewater treatment system 2 according to the present disclosure may be the same as or similar to those described with reference to FIGS. 1 to 7, except that a plurality of separation membrane contactors 30 may be included.

Referring to FIG. 8, the fluorine-containing wastewater treatment system 2 may include a first separation membrane contactor 30a directly receiving wastewater 11 from a first supply assembly 10, and a second separation membrane contactor 30b connected in series to the first separation membrane contactor 30a, the second separation membrane contactor 30b receiving the primarily treated wastewater 12 (hereinafter referred to as “first treated wastewater”) from the first separation membrane contactor 30a.

The first separation membrane contactor 30a may include a body 31a, a separation membrane 32a, a plurality of inlets 33a and 34a, and a plurality of outlets 35a and 36a, and the above-described components 31a, 32a, 33a, 34a, 35a, and 36a may be respectively the same as the components 31, 32, 33, 34, 35, and 36 of the separation membrane contactor 30 described with reference to FIGS. 1 to 7, and thus a detailed description will be omitted.

The second separation membrane contactor 30b may include components the same as or similar to those of the first separation membrane contactor 30a. For example, the second separation membrane contactor 30b may include a body 31b, and a separation membrane 32b embedded in the body 31b to perform a separation process.

The body 31b may include a plurality of inlets for supplying the first treated wastewater 12 and an absorbent 21 to a separation membrane 32, and a plurality of outlets for discharging first treated water 41 and second treated water 51 from the second separation membrane contactor 30b.

The plurality of inlets may include, for example, a second inlet channel 33b (or “second shell side inlet”) disposed on a lower side portion of the body 31, the second inlet channel 33b for receiving the first treated wastewater 12 from the first separation membrane contactor 30a, and a second inlet 34b (or “second tube side inlet”) disposed on an upper portion of the body 31, the second inlet 34b for receiving the absorbent 21 from a second supply assembly 20.

The plurality of outlets may include, for example, a second outlet channel 35b (or “first shell side outlet”) disposed on an upper side portion of the body 31, the second outlet channel 35b for discharging the first treated water 41, and a second outlet 36b (or “second tube side outlet”) disposed on a lower portion of the body 31, the second outlet 36b for discharging the second treated water 51.

In the present example embodiment, the first separation membrane contactor 30a and the second separation membrane contactor 30b may be connected to each other in series, such that process time required to treat fluorine from the fluorine-containing wastewater 11 may be reduced, thereby increasing process efficiency. For example, as described with reference to FIGS. 1 to 7, the first treated wastewater 12, treated by the first separation membrane contactor 30a, may be directly recovered by a first treated water recovery assembly 40, and may then be introduced into the second inlet channel 33b of the second separation membrane contactor 30b to be subject to an additional separation process. Stages of the separation membrane contactors 30 used in the fluorine-containing treatment system 2 according to the present example embodiment is not limited to two stages. For example, three or more stages may be included, as necessary.

Although not illustrated, a plurality of separation membrane contactors may be connected to each other in parallel, or may be connected to each other in a combination of parallel and series, as necessary.

According to example embodiments of the present disclosure, a fluoride-containing wastewater treatment system may convert fluoride of fluoride-containing wastewater into gas-phase fluoride, and may selectively separate the gas-phase fluoride, using a separation membrane contactor including a hydrophobic separation membrane, thereby minimizing the generation of a large amount of inorganic sludge and recovering highly concentrated fluoride-containing treated water. As a result, additional costs for treating inorganic sludge may be reduced, and the highly concentrated fluoride-containing treated water may be recycled as a raw material for manufacturing hydrofluoric acid.

While example embodiments have been shown and described above, it will be apparent to those skilled in the art that modifications and variations could be made without departing from the scope of the present disclosure as defined by the appended claims.

What is claimed is:

1. A fluorine-containing wastewater treatment system comprising:
a separation membrane contactor including a hydrophobic separation membrane having a plurality of pores, the separation membrane contactor performing a separation process with the hydrophobic separation membrane;
a first supply assembly configured to supply treatment target water containing fluorine to the separation membrane contactor;
a second supply assembly configured to supply an absorbent to the separation membrane contactor, wherein the absorbent is physically separated from the treatment target water by the hydrophobic separation membrane, and the fluorine of the treatment target water is absorbed by the absorbent through the plurality of pores of the hydrophobic separation membrane, using the separation process;
a first treated water recovery assembly configured to selectively recover first treated water having a first fluorine concentration from the separation membrane contactor, wherein the first treated water is treated water obtained by treating the treatment target water using the separation process; and
a second treated water recovery assembly configured to selectively recover second treated water having a second fluorine concentration from the separation membrane contactor, wherein the second treated water is a solution containing the absorbent including the fluorine from the treatment target water using the separation process,
wherein the first fluorine concentration is within a first weight management range of the separation process, and
wherein the second fluorine concentration is higher than a second weight management range of the separation process, and the second weight management range is greater than the first weight management range.

2. The fluorine-containing wastewater treatment system of claim 1, wherein the first weight management range is a range in which the first fluorine concentration is about 0.1 wt % or less relative to a weight of the first treated water.

3. The fluorine-containing wastewater treatment system of claim 1, wherein the second weight management range is a range in which the second fluorine concentration is about 20 wt % or more relative to a weight of the second treated water.

4. The fluorine-containing wastewater treatment system of claim 1, wherein the second weight management range is a range in which the second fluorine concentration is at least twice a concentration of the fluorine of the treatment target water.

5. The fluorine-containing wastewater treatment system of claim 1, wherein the fluorine of the treatment target water is converted to gas-phase fluorine in a portion adjacent to the plurality of pores, and diffuses toward the absorbent through the plurality of pores, and
the fluorine reacts with the absorbent and is fixed to the absorbent.

6. The fluorine-containing wastewater treatment system of claim 1, wherein the absorbent is selected from the group consisting of NaOH, KOH, and NH₄OH.

7. The fluorine-containing wastewater treatment system of claim 1, wherein the absorbent includes a basic solution, and the basic solution does not contain Ca(OH)₂.

8. The fluorine-containing wastewater treatment system of claim 1, further comprising:
a treatment target water pretreatment assembly between the first supply assembly and the separation membrane contactor,
wherein the treatment target water pretreatment assembly includes:
a first pretreatment assembly configured to adjust a pH of the treatment target water of the first supply assembly; and
a second pretreatment assembly configured to remove particulate matter in the treatment target water of the first supply assembly.

9. The fluorine-containing wastewater treatment system of claim 8, wherein the first pretreatment assembly is configured to inject acid to maintain the pH of the treatment target water at less than an acid ionization constant (pKa) of the fluorine.

10. The fluorine-containing wastewater treatment system of claim 8, wherein the first pretreatment assembly is configured to inject acid such that the pH of the treatment target water is about 2.0 or less.

11. The fluorine-containing wastewater treatment system of claim 1, further comprising:
a treated water circulation assembly between the separation membrane contactor and the first treated water recovery assembly,
wherein treated water, having a fluorine concentration outside the first weight management range, of the first treated water is reintroduced into the first supply assembly by the treated water circulation assembly.

12. The fluorine-containing wastewater treatment system of claim 11, further comprising:
a treated water monitoring assembly between the separation membrane contactor and the treated water circulation assembly,
wherein the treated water monitoring assembly is configured to monitor the first fluorine concentration of the first treated water.

13. The fluorine-containing wastewater treatment system of claim 1, further comprising:
an absorbent pretreatment assembly between the second supply assembly and the separation membrane contactor,
wherein the absorbent pretreatment assembly includes:
a first pretreatment assembly configured to adjust a concentration of the absorbent in the second supply assembly; and
a second pretreatment assembly configured to remove particulate matter in the absorbent of the second supply assembly.

14. The fluorine-containing wastewater treatment system of claim 1, further comprising:
an absorbent circulation assembly between the separation membrane contactor and the second treated water recovery assembly,
wherein treated water, having a fluorine concentration lower than the second weight management range, of the second treated water is reintroduced into the second supply assembly by the absorbent circulation assembly.

15. The fluorine-containing wastewater treatment system of claim 14, further comprising:
an absorbent monitoring assembly between the separation membrane contactor and the absorbent circulation assembly,
wherein the second treated water contains a fluorine salt produced by reaction of at least a portion of the fluorine of the treatment target water and the absorbent, and
the absorbent monitoring assembly is configured to monitor the second fluorine concentration of the second treated water, and whether the fluorine salt of the second treated water is precipitated.

16. A fluorine-containing wastewater treatment system comprising:
a separation membrane contactor including a hydrophobic hollow fiber membrane having a plurality of pores, the separation membrane contactor performing a separation process with the hydrophobic hollow fiber membrane;
a first supply assembly configured to supply treatment target water containing fluorine such that the treatment target water is in contact with an external surface of the hydrophobic hollow fiber membrane of the separation membrane contactor;
a second supply assembly configured to supply an absorbent such that the absorbent is in contact with an internal surface of the hydrophobic hollow fiber membrane of the separation membrane contactor,
wherein the fluorine of the treatment target water is converted into gas-phase fluorine in a portion adjacent to the plurality of pores, using the separation process, and the gas-phase fluorine diffuses toward the absorbent through the plurality of pores and is absorbed by the absorbent; and
a first treated water recovery assembly configured to selectively recover first treated water from the separation membrane contactor, the first treated water containing a first fluorine concentration using the separation process,
wherein the first fluorine concentration is within a first weight management range of the separation process.

17. The fluorine-containing wastewater treatment system of claim 16, wherein the hydrophobic hollow fiber membrane is selected from the group consisting of polytetrafluoroethylene (PTFE), polypropylene (PP), polyvinylidene fluoride (PVDF), and polydimethylsiloxane (PDMS).

18. The fluorine-containing wastewater treatment system of claim 16, wherein a surface of the hydrophobic hollow fiber membrane is surface-treated using plasma polymerization or silane coating.

19. The fluorine-containing wastewater treatment system of claim 16, further comprising:
a second treated water recovery assembly configured to selectively recover second treated water from the separation membrane contactor, the second treated water containing a second fluorine concentration using the separation process,
wherein the second fluorine concentration is higher than a second weight management range of the separation process,
wherein the first weight management range is a range in which the first fluorine concentration is about 0.1 wt % or less relative to a weight of the first treated water, and
wherein the second weight management range is a range in which the second fluorine concentration is about 30 wt % or more relative to a weight of the second treated water.

20. A fluorine-containing wastewater treatment system comprising:
a separation membrane contactor including a hydrophobic separation membrane having a plurality of pores, the separation membrane contactor performing a separation process by the hydrophobic separation membrane;
a first supply assembly configured to supply treatment target water containing fluorine to the separation membrane contactor;
a second supply assembly configured to supply an absorbent to the separation membrane contactor, wherein the absorbent is physically separated from the treatment target water by the hydrophobic separation membrane, and the fluorine of the treatment target water is absorbed by the absorbent through the plurality of pores of the hydrophobic separation membrane using the separation process;
a treatment target water pretreatment assembly disposed between the first supply assembly and the separation membrane contactor, the treatment target water pretreatment assembly configured to inject acid to maintain a pH of the treatment target water at less than an acid ionization constant (pKa) of the fluorine;
a first treated water recovery assembly configured to selectively recover first treated water containing a first fluorine concentration from the separation membrane contactor, wherein the first treated water is treated water obtained by treating the treatment target water using the separation process; and
a second treated water recovery assembly configured to selectively recover second treated water containing a second fluorine concentration from the separation membrane contactor, wherein the second treated water is a solution containing the absorbent including the fluorine from the treatment target water using the separation process,
wherein the first fluorine concentration is within a first weight management range of the separation process,
wherein the second fluorine concentration is higher than a second weight management range of the separation process,
wherein the first weight management range is a range in which the first fluorine concentration is about 0.1 wt % or less relative to a weight of the first treated water, and
wherein the second weight management range is a range in which the second fluorine concentration is at least twice a concentration of the fluorine of the treatment target water.
